(19) United States
(12) Patent Application Publication
(10) Pub. No.: US 2025/0307594 A1
(43) Pub. Date: Oct. 2, 2025

(54) ANTENNA DEVICE AND IC CARD HAVING THE SAME

(71) Applicant: TDK Corporation, Tokyo (JP)

(72) Inventors: Toshio TOMONARI, Tokyo (JP); Shoma KAJIKIYA, Tokyo (JP); Makoto HIRAKI, Tokyo (JP)

(73) Assignee: TDK Corporation, Tokyo (JP)

(21) Appl. No.: 19/090,412

(22) Filed: Mar. 26, 2025

(30) Foreign Application Priority Data
Mar. 27, 2024 (JP) 2024-051380

(51) Int. Cl. G06K 19/077; G06K 19/07; H01Q 1/22

(52) U.S. Cl. CPC G06K 19/07781; G06K 19/0723; H01Q 1/2283

(57) ABSTRACT

Disclosed herein is an antenna device that includes a coil conductor arranged between first and second magnetic bodies in the axial direction. The first magnetic body has a first area that overlaps the opening area of the coil conductor, a second area that protrudes from the first area to one side in a first direction, and a third area that protrudes from the first area to one side in a second direction. The second magnetic body has a fourth area that overlaps the opening area in the axial direction, a fifth area that protrudes from the fourth area to the other side in the first direction, and a sixth area that protrudes from the fourth area to the other side in the second direction. The first magnetic body has a first cutout area.

### CROSS-REFERENCE TO RELATED APPLICATION

This application claims the benefit of Japanese Patent Application No. 2024-051380, filed on Mar. 27, 2024, the entire disclosure of which is incorporated by reference herein.

### BACKGROUND OF THE ART

### Field of the Art

The present disclosure relates to an antenna device and an IC card having the same.

### Description of Related Art

JP 2002-324221A discloses a tag antenna coil having a structure in which a coil body is axially sandwiched by two magnetic core members SO that magnetic flux substantially parallel to the axial direction easily interlinks with the coil body.

However, the tag antenna coil described in JP 2002-324221A has a problem that many magnetic flux components flow through the magnetic core member so as to bypass the coil body without interlinking therewith.

### SUMMARY

An antenna device according to an aspect of the present disclosure includes: a coil conductor; a first magnetic body disposed on one side as viewed from the coil conductor in the axial direction; and a second magnetic body disposed on the other side as viewed from the coil conductor in the axial direction. The first magnetic body has a first area that overlaps the opening area of the coil conductor in the axial direction; a second area that protrudes from the first area to one side in a first direction and overlaps the coil conductor; and a third area that protrudes from the first area to one side in a second direction perpendicular to the first direction and overlaps the coil conductor. The second magnetic body has a fourth area that overlaps the opening area of the coil conductor in the axial direction; a fifth area that protrudes from the fourth area to the other side in the first direction and overlaps the coil conductor; and a sixth area that protrudes from the fourth area to the other side in the second direction and overlaps the coil conductor. The first magnetic body has a first cutout area such that an outer peripheral edge of the first magnetic body is positioned at the inner side than a first intersection between a first virtual line obtained by extending the outer peripheral edge of the second area in the second direction and a second virtual line obtained by extending the outer peripheral edge of the third area in the first direction.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic perspective view illustrating the outer appearance of an IC card 2 having an antenna device according to an embodiment of the present disclosure;

FIG. 2 is a schematic exploded perspective view for explaining the structure of the IC card 2;

FIG. 3 is a YZ cross-sectional view of the IC card 2;

FIG. 4 is an XZ cross-sectional view of the IC card 2;

FIG. 5 is a schematic plan view for explaining the configuration of the antenna device 1;

FIG. 6 is a schematic plan view for explaining the shapes of the magnetic bodies 20 and 40;

FIG. 7 is a schematic perspective view of the IC module 60 as viewed from the back surface side;

FIG. 8 is a schematic diagram showing a state in which the IC card 2 and the card reader 6 communicate with each other;

FIG. 9 is a YZ cross-sectional view of a card 3 according to a first modification;

FIG. 10 is a schematic plan view for explaining the structure of the antenna device 1 applicable to the IC card 3 according to the first modification;

FIG. 11 is a schematic plan view for explaining the shapes of the magnetic bodies 20 and 40 used for the IC card 3 according to the first modification;

FIG. 12 is a schematic plan view for explaining the shapes of the magnetic bodies 20 and 40 according to a second modification;

FIG. 13 is a schematic plan view for explaining the shapes of the magnetic bodies 20 and 40 according to a third modification;

FIG. 14 is a schematic plan view for explaining the shapes of the magnetic bodies 20 and 40 according to a fourth modification;

FIG. 15 is a schematic plan view for explaining the shapes of the magnetic bodies 20 and 40 according to a fifth modification;

FIG. 16 is a schematic plan view for explaining the shapes of the magnetic bodies 20 and 40 according to a sixth modification;

FIG. 17 is a schematic plan view for explaining the shapes of the magnetic bodies 20 and 40 according to a seventh modification; and

FIG. 18 is a YZ cross-sectional view of an IC card 4 according to an eighth modification.

### DETAILED DESCRIPTION OF THE EMBODIMENTS

The present disclosure relates to an antenna device having a coil conductor and two magnetic bodies arranged so as to axially sandwich the coil conductor and describes a technology for allowing more magnetic flux components to interlink with the coil conductor while suppressing magnetic flux components that flow through a magnetic core member so as to bypass the coil conductor without interlinking therewith.

Some embodiments of the present disclosure will be explained below in detail with reference to the accompanying drawings.

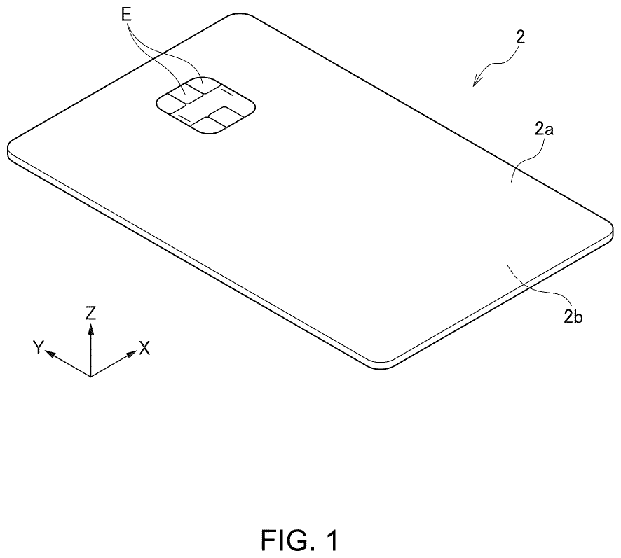

FIG. 1 is a schematic perspective view illustrating the outer appearance of an IC card 2 having an antenna device according to an embodiment of the present disclosure.

As illustrated in FIG. 1, the IC card 2 according to the present embodiment has a plate-like body in which the Y-, X-, and Z-directions thereof are respectively defined as the longer side direction, shorter side direction, and thickness direction and has an upper surface 2a and a back surface 2b which constitute the XY plane. The IC card 2 incorporates therein an IC module to be described later, and a terminal electrode E of the IC module is exposed to the upper surface 2a of the IC card 2.

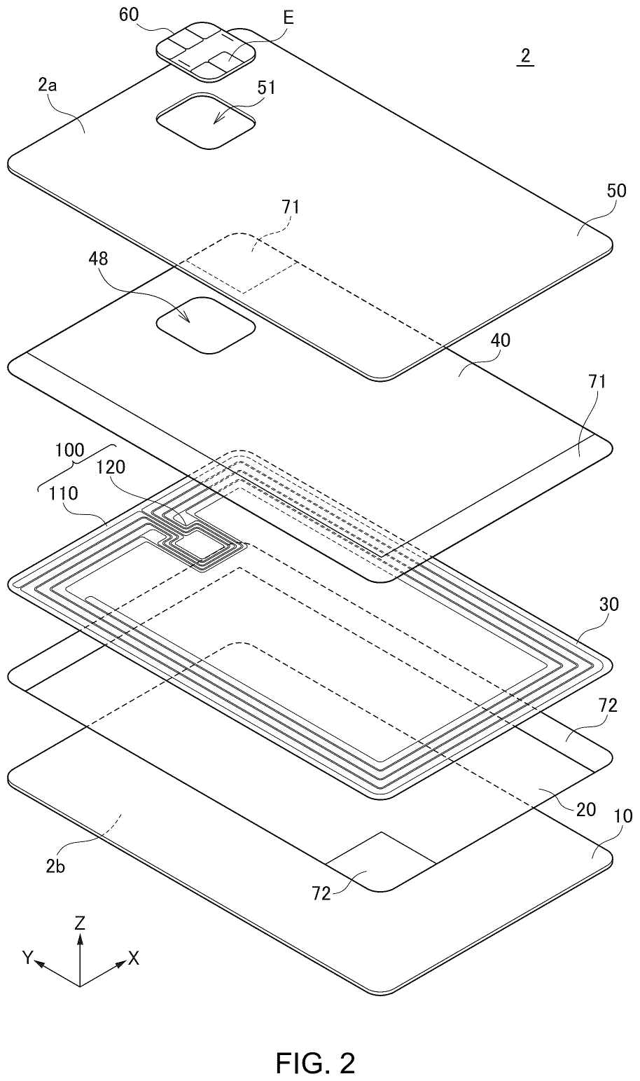

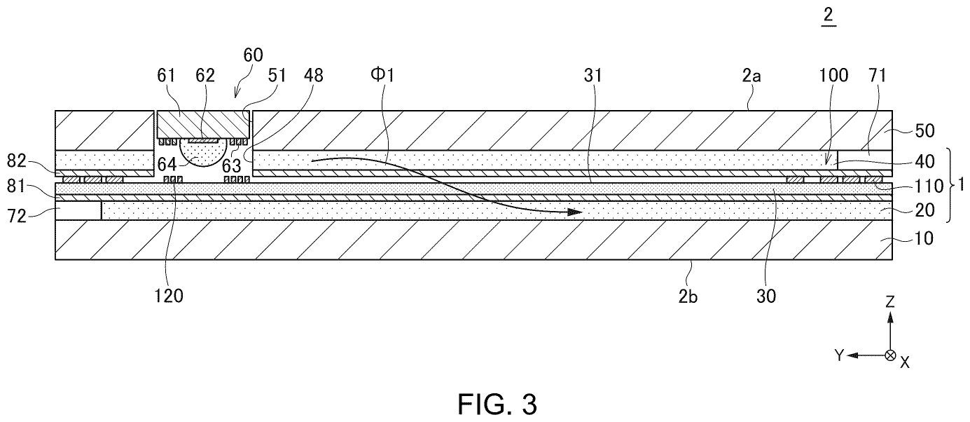

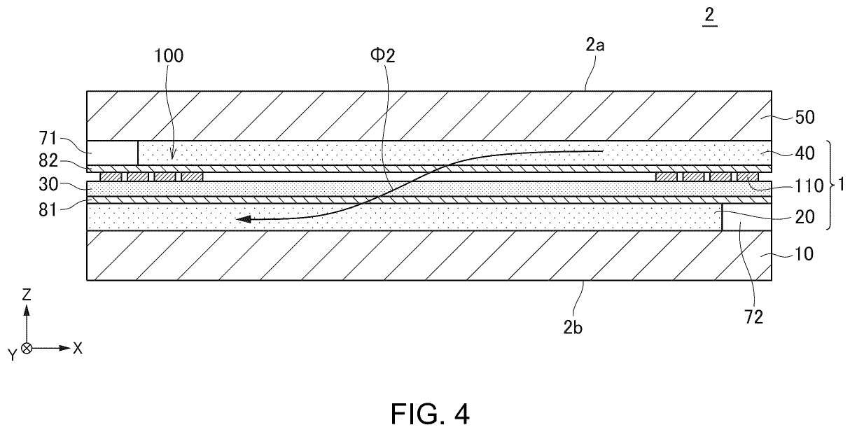

FIG. 2 is a schematic exploded perspective view for explaining the structure of the IC card 2 having an antenna device 1 according to the present embodiment. FIG. 3 is a YZ cross-sectional view of the IC card 2. FIG. 4 is an XZ cross-sectional view of the IC card 2.

The IC card 2 illustrated in FIGS. 2 to 4 has a structure in which a metal plate 10, the antenna device 1, and a metal plate 50 are laminated in this order from the back surface 2b side to the upper surface 2a side. The metal plate 10 is a first card substrate constituted by metal such as stainless steel or titanium, and one surface thereof constitutes the back surface 2b of the IC card 2. The metal plate 50 is a second card substrate constituted by metal such as stainless steel or titanium, and one surface thereof constitutes the upper surface 2a of the IC card 2. As described above, the IC card 2 is a card formed by using the metal plates for the main body thereof.

The antenna device 1 according to the present embodiment is composed of magnetic bodies 20 and 40 and a coil conductor 100 sandwiched in the Z-direction between the magnetic bodies 20 and 40. The coil conductor 100 includes coil patterns 110 and 120 and is formed on a surface 31 of a substrate 30 made of a PET film or polyimide film. The axial direction of the coil patterns 110 and 120 is the Z-direction, and thus the magnetic body 40 is disposed on one side (positive Z-direction side) in the axial direction as viewed from the coil conductor 100, and the magnetic body 20 is disposed on the other side (negative Z-direction side) in the axial direction as viewed from the coil conductor 100. The substrate 30 and magnetic body 20 are bonded to each other through an adhesive layer 81. The substrate 30 and magnetic body 40 are bonded to each other through an adhesive layer 82. Examples of the material of adhesive layers 81 and 82 include an acrylic-based double-sided tape, a thermosetting resin, and a thermoplastic resin.

The magnetic body 40 and metal plate 50 respectively have a through hole 48 and a through hole 51. The through holes 48 and 51 overlap each other in the Z-direction which is the lamination direction. An IC module 60 is disposed inside the through hole 51 of the metal plate 50.

The IC module 60 includes a module substrate 61, an IC chip 62 mounted on or incorporated in the module substrate 61, and a coupling coil 63. The IC chip 62 is protected by being covered with a dome-shaped protective resin 64. The terminal electrode E illustrated in FIG. 1 is provided on the surface of the module substrate 61 on the opposite side of the surface on which the IC chip 62 is provided. The IC module 60 thus configured is electromagnetically coupled to the coil pattern 120 constituting a part of the coil conductor 100. This enables communication between the IC chip 62 and an external card reader through the coil pattern 110 constituting the other part of the coil conductor 100. That is, the coil pattern 110 serves as an antenna coil, and coil pattern 120 serves as a coupling coil.

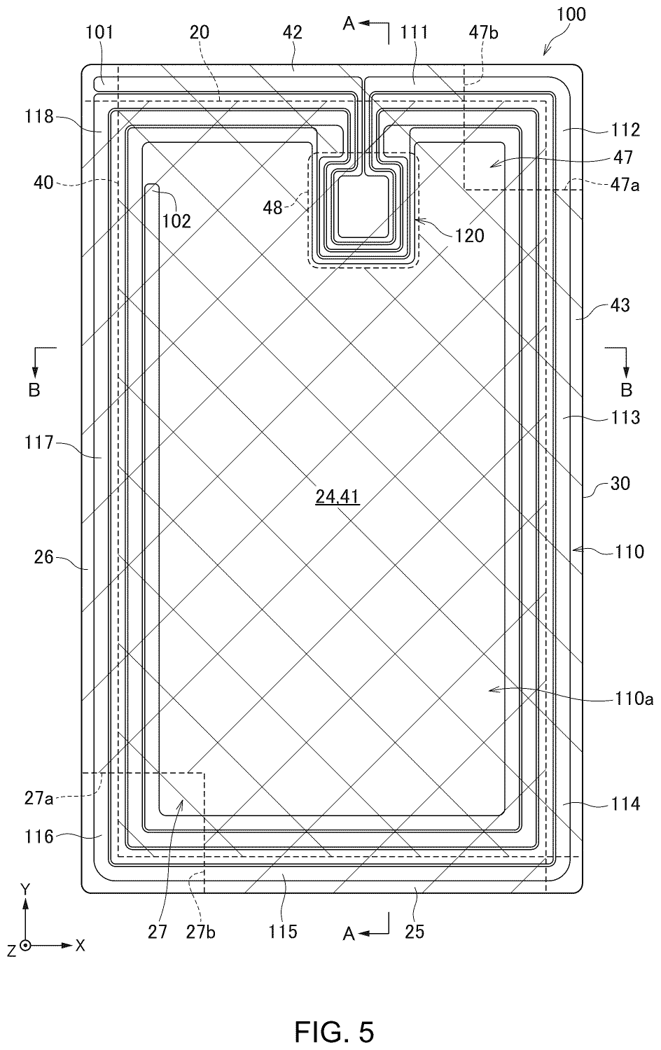

FIG. 5 is a schematic plan view for explaining the configuration of the antenna device 1 according to the present embodiment. The line A-A in FIG. 5 indicates the sectional position of FIG. 3, and the line B-B in FIG. 5 indicates the sectional position of FIG. 4.

As illustrated in FIG. 5, the coil conductor 100 included in the antenna device 1 according to the present embodiment includes a coil pattern 110 wound in a plurality of turns along the outer edge of the substrate 30 and a coil pattern 120 wound in a plurality of turns connected respectively to the turns of the coil pattern 110 and disposed so as to overlap the through hole 48 of the magnetic body 40. The coil patterns 110 and 120 are positioned on the same plane. The coil pattern 120 overlaps, in the Z-direction, the IC module 60 disposed inside the through hole 51 of the metal plate 50 through the through hole 48 of the magnetic body 40.

In the example illustrated in FIG. 5, the coil patterns 110 and 120 are both wound in about four turns. The coil pattern 120 is a part that protrudes toward an opening area 110a of the coil pattern 110. That is, each turn of the coil conductor 100 includes the coil pattern 110 with less than one turn and coil pattern 120 with less than one turn.

The coil pattern 110 functions as an antenna coil coupled to an external card reader in actual use. The coil pattern 120 functions as a coupling coil coupled to the IC module 60. The coil pattern 120 may functions as a part of the antenna coil coupled to the external card reader. When outer and inner peripheral ends 101 and 102 of the coil conductor 100 are set as starting and end points, respectively, the coil patterns 110 and 120 are respectively wound right-handed (clockwise direction) and left-handed (counterclockwise direction) as viewed in the direction of FIG. 5. That is, the coil patterns 110 and 120 are wound in mutually opposite directions.

The coil pattern 110 has first and fifth sections 111 and 115 including a portion extending in the X-direction (first direction), third and seventh sections 113 and 117 including a portion extending in the Y-direction (second direction), and second, fourth, sixth, and eighth sections 112, 114, 116, and 118 including a portion bent so as to change its extending direction (from the X- to Y-direction or from the Y- to X-direction).

One end of the first section 111 is connected to one end of the second section 112. The other end of the second section 112 is connected to one end of the third section 113. The other end of the third section 113 is connected to one end of the fourth section 114. The other end of the fourth section 114 is connected to one end of the fifth section 115. The other end of the fifth section 115 is connected to one end of the sixth section 116. The other end of the sixth section 116 is connected to one end of the seventh section 117. The other end of the seventh section 117 is connected to one end of the eighth section 118. The other end of the eighth section 118 is connected to the other end of the first section 111. The turns constituting the coil pattern 120 are connected to the first section 111 of the coil pattern 110.

As illustrated in FIG. 5, both the magnetic bodies 20 and 40 overlap a part of the coil pattern 110 and a part of the opening area 110a in a plan view (as viewed in the Z-direction).

The magnetic body 40 (first magnetic body) has a first area 41, a second area 42, and a third area 43. The first area 41 overlaps the opening area 110a of the coil pattern 110 in the Z-direction (axial direction). The second area 42 protrudes in the positive Y-direction (one side in the Y-direction) from the first area 41 so as to overlap the first section 111 of the coil pattern 110 in the Z-direction. The third area 43 protrudes in the positive X-direction (one side in the X-direction) from the first area 41 so as to overlap the third section 111 of the coil pattern 110 in the Z-direction. The through hole 48 of the magnetic body 40 is formed in the first area 41. The second area 42 of the magnetic body 40 may include a portion extending to the outside area of the coil pattern 110 beyond the first section 111 of the coil pattern 110. The third area 43 of the magnetic body 40 may include a portion extending to the outside area of the coil pattern 110 beyond the third section 113 of the coil pattern 110. The magnetic body 40 partially overlaps the fourth, fifth, sixth, seventh, and eight sections 114, 115, 116, 117, and 118 of the coil pattern 110 but does not include a portion extending to the outside area of the coil pattern 110 beyond the fourth, fifth, sixth, seventh, and eight sections 114, 115, 116, 117, and 118. The magnetic body 40 does not overlap the second section 112 of the coil pattern 110.

The magnetic body 20 (second magnetic body) has a fourth area 24, a fifth area 25, and a sixth area 26. The fourth area 24 overlaps the opening area 110a of the coil pattern 110 in the Z-direction (axial direction). The fifth area 25 protrudes in the negative Y-direction (the other side in the Y-direction) from the fourth area 24 so as to overlap the fifth section 115 of the coil pattern 110 in the Z-direction. The sixth area 26 protrudes in the negative X-direction (the other side in the X-direction) from the fourth area 24 so as to overlap the seventh section 117 of the coil pattern 110 in the Z-direction. The fourth area 24 of the magnetic body 20 has a portion overlapping the coil pattern 120 in the Z-direction. The fifth area 25 of the magnetic body 20 may include a portion extending to the outside area of the coil pattern 110 beyond the fifth section 115 of the coil pattern 110. The sixth area 26 of the magnetic body 20 may include a portion extending to the outside area of the coil pattern 110 beyond the seventh section 117 of the coil pattern 110. The magnetic body 20 partially overlaps the first, second, third, fourth, and eighth sections 111, 112, 113, 114, and 118 of the coil pattern 110 but does not include a portion extending to the outside area of the coil pattern 110 beyond the first, second, third, fourth, and eighth sections 111, 112, 113, 114, and 118. The magnetic body 20 does not overlap the sixth section 116 of the coil pattern 110.

The first area 41 of the magnetic body 40 and fourth area 24 of the magnetic body 20 overlap each other in the Z-direction (axial direction).

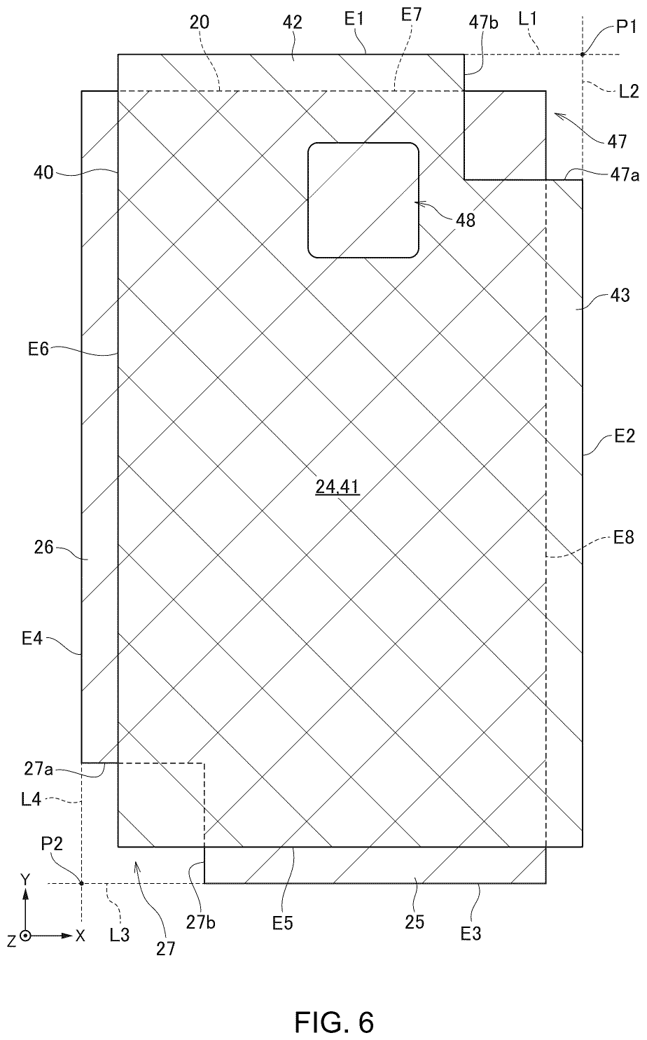

FIG. 6 is a schematic plan view for explaining the shapes of the magnetic bodies 20 and 40.

As illustrated in FIG. 6, the magnetic body 40 has an outer peripheral edge E1 constituting the end portion of the second area 42 in the positive Y-direction and extending in the X-direction and an outer peripheral edge E2 constituting the end portion of the third area 43 in the positive X-direction and extending in the Y-direction. When a first virtual line L1 obtained by extending the outer peripheral edge E1 in the positive X-direction and a second virtual line L2 obtained by extending the outer peripheral edge E2 in the positive Y-direction are assumed, the magnetic body 40 has a first cutout area 47 at a portion adjacent to the first and second virtual lines L1 and L2. That is, edges 47a and 47b defining the first cutout area 47 are positioned at the inner side than an intersecting point P1 between the first and second virtual lines L1 and L2.

As described above, the second area 42 of the magnetic body 40 may include a portion extending to the outside area of the coil pattern 110 beyond the first section 111 of the coil pattern 110. In this case, the outer peripheral edge E1 of the magnetic body 40 is positioned at the outside area of the coil pattern 110. Similarly, the third area 43 of the magnetic body 40 may include a portion extending to the outside area of the coil pattern 110 beyond the third section 113 of the coil pattern 110. In this case, the outer peripheral edge E2 of the magnetic body 40 is positioned at the outside area of the coil pattern 110.

On the other hand, an outer peripheral edge E5 of the magnetic body 40 extending in the X-direction and positioned on the opposite side of the outer peripheral edge E1 may overlap the fifth section 115 of the coil pattern 110 but need not include a portion extending to the outside area of the coil pattern 110 beyond the fifth section 115 of the coil pattern 110. In this case, the outer peripheral edge E5 of the magnetic body 40 is positioned at the inner side than the outside area of the coil pattern 110. Similarly, an outer peripheral edge E6 of the magnetic body 40 extending in the Y-direction and positioned on the opposite side of the outer peripheral edge E2 may overlap the seventh section 117 of the coil pattern 110 but need not include a portion extending to the outside area of the coil pattern 110 beyond the seventh section 117 of the coil pattern 110. In this case, the outer peripheral edge E6 of the magnetic body 40 is positioned at the inner side than the outside area of the coil pattern 110.

As illustrated in FIG. 6, the magnetic body 20 has an outer peripheral edge E3 constituting the end portion of the fifth area 25 in the negative Y-direction and extending in the X-direction and an outer peripheral edge E4 constituting the end portion of the sixth area 26 in the negative X-direction and extending in the Y-direction. When a third virtual line L3 obtained by extending the outer peripheral edge E3 in the negative X-direction and a fourth virtual line L4 obtained by extending the outer peripheral edge E4 in the negative Y-direction are assumed, the magnetic body 20 has a second cutout area 27 at a portion adjacent to the third and fourth virtual lines L3 and L4. That is, edges 27a and 27b defining the second cutout area 27 are positioned at the inner side than an intersecting point P2 between the third and fourth virtual lines L3 and L4.

As described above, the fifth area 25 of the magnetic body 20 may include a portion extending to the outside area of the coil pattern 110 beyond the fifth section 115 of the coil pattern 110. In this case, the outer peripheral edge E3 of the magnetic body 20 is positioned at the outside area of the coil pattern 110. Similarly, the sixth area 26 of the magnetic body 20 may include a portion extending to the outside area of the coil pattern 110 beyond the seventh section 117 of the coil pattern 110. In this case, the outer peripheral edge E4 of the magnetic body 20 is positioned at the outside area of the coil pattern 110.

On the other hand, an outer peripheral edge E7 of the magnetic body 20 extending in the X-direction and positioned on the opposite side of the outer peripheral edge E3 may overlap the first section 111 of the coil pattern 110 but need not include a portion extending to the outside area of the coil pattern 110 beyond the first section 111 of the coil pattern 110. In this case, the outer peripheral edge E7 of the magnetic body 20 is positioned at the inner side than the outside area of the coil pattern 110. Similarly, an outer peripheral edge E8 of the magnetic body 20 extending in the Y-direction and positioned on the opposite side of the outer peripheral edge E4 may overlap the third section 113 of the coil pattern 110 but need not include a portion extending to the outside area of the coil pattern 110 beyond the third section 113 of the coil pattern 110. In this case, the outer peripheral edge E8 of the magnetic body 20 is positioned at the inner side than the outside area of the coil pattern 110.

Thus, as illustrated in FIG. 3, when Y-direction magnetic flux ϕ1 is applied to the antenna device: according to the present embodiment, it flows through, for example, the second area 42 of the magnetic body 40, first area 41 of the magnetic body 40, fourth area 24 of the magnetic body 20, and fifth area 25 of the magnetic body 20 so as to interlink with the coil pattern 110. Further, as illustrated in FIG. 4, when X-direction magnetic flux ϕ2 is applied to the antenna device 1 according to the present embodiment, it flows through, for example, the third area 43 of the magnetic body 40, first area 41 of the magnetic body 40, fourth area 24 of the magnetic body 20, and sixth area 26 of the magnetic body 20 so as to interlink with the coil pattern 110. Therefore, in the antenna device 1 according to the present embodiment, XY plane direction magnetic flux can be made to interlink with the coil pattern 110 even through the antenna device 1 is sandwiched between the metal plates 10 and 50 in the Z-direction (axial direction).

On the other hand, a part of the XY plane direction magnetic flux passes through the second, first, and third areas 42, 41, and 43 of the magnetic body 40 without interlinking with the coil pattern 110, and another part of the XY plane direction magnetic flux passes through the fifth, fourth, and sixth areas 25, 24, and 26 of the magnetic body 20 without interlinking with the coil pattern 110. Such magnetic flux components do not interlink with the coil pattern 110 and thus do not contribute to communication. However, in the present embodiment, since the magnetic bodies 40 and 20 have the first and second cutout areas 47 and 27, respectively, magnetic flux components that do not interlink with the coil pattern 110 are reduced.

The first cutout area 47 of the magnetic body 40 is provided at a position overlapping the second section 112 of the coil pattern 110, and thus the magnetic body 40 does not overlap the second section 112 of the coil pattern 110. The first cutout area 47 of the magnetic body 40 is positioned on the positive X-direction side of the second area 42 of the magnetic body 40 and on the positive Y-direction side of the third area 43 of the magnetic body 40. The edges 47a and 47b defining the first cutout area 47 extend in the X- and Y-directions, respectively.

Accordingly, the angle formed by the edges 47a and 47b is substantially 90°.

Since the magnetic body 40 has the thus provided first cutout area 47, magnetic flux components that bypass the coil pattern 110 from the second area 42 of the magnetic body 40 to third area 43 without interlinking therewith or bypasses the coil pattern 110 from the third area 43 of the magnetic body 40 to second area 42 without interlinking therewith are reduced, so that more magnetic flux components interlink with the coil pattern 110 to flow in the magnetic body 20. The first cutout area 47 of the magnetic body 40 may overlap the opening area 110a of the coil pattern 110. This can further reduce magnetic flux components that flow through the magnetic body 40 so as to bypass the coil pattern 110 without interlinking therewith.

The second cutout area 27 of the magnetic body 20 is provided at a position overlapping the sixth section 116 of the coil pattern 110, and thus the magnetic body 20 does not overlap the sixth section 116 of the coil pattern 110.

The second cutout area 27 of the magnetic body 20 is positioned on the negative X-direction side of the fifth area 25 of the magnetic body 20 and on the negative Y-direction side of the sixth area 26 of the magnetic body 20. The edges 27a and 27b defining the second cutout area 27 extend in the X- and Y-directions, respectively. Accordingly, the angle formed by the edges 27a and 27b is substantially 90°.

Since the magnetic body 20 has the thus provided second cutout area 27, magnetic flux components that bypass the coil pattern 110 from the fifth area 25 of the magnetic body 20 to sixth area 26 without interlinking therewith or bypass the coil pattern 110 from the sixth area 26 of the magnetic body 20 to fifth area 25 without interlinking therewith are reduced, so that more magnetic flux components interlink with the coil pattern 110 to flow in the magnetic body 40. The second cutout area 27 of the magnetic body 20 may overlap the opening area 110a of the coil pattern 110. This can further reduce magnetic flux components that flow through the magnetic body 20 so as to bypass the coil pattern 110 without interlinking therewith.

Further, in the example illustrated in FIG. 6, the magnetic bodies 20 and 40 have the same outer shape. This allows the magnetic bodies 20 and 40 to be manufactured in the same process. For example, when the magnetic bodies 20 and 40 are formed of a magnetic sheet, cutting of the magnetic body 20 and cutting of the magnetic body 40 can be performed at the same time. Then, the through hole 48 is formed in one of the magnetic sheets, whereby the magnetic body 40 is completed. However, the magnetic bodies 20 and 40 need not necessarily have the same shape but may have mutually different shapes. For example, the magnetic body 20 may not have the second cutout area 27.

As illustrated in FIGS. 2 to 4, a first spacer 71 may be disposed in the same plane as the magnetic body 40, and a second spacer 72 may be disposed in the same plane as the magnetic body 20. The first and second spacers 71 and 72 are each a nonmagnetic insulating member made of resin. The first spacer 71 is a member for filling a space in the same place as the magnetic body 40 where the magnetic body 40 is absent and partially overlaps the magnetic body 20. The second spacer 72 is a member for filling a space in the same place as the magnetic body 20 where the magnetic body 20 is absent and partially overlaps the magnetic body 40. The presence of such first and second spacers 71 and 72 can enhance the flatness of both surfaces of the antenna device 1.

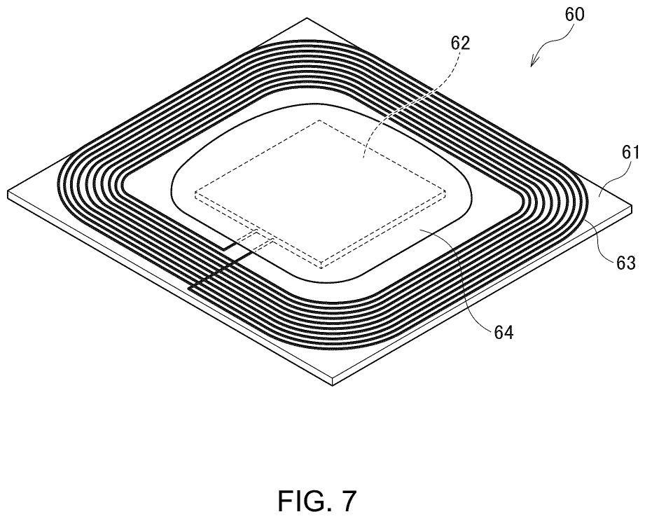

FIG. 7 is a schematic perspective view of the IC module 60 as viewed from the back surface side.

As illustrated in FIG. 7, the IC module 60 includes a module substrate 61, an IC chip 62 mounted on or incorporated in the module substrate 61, and a coupling coil 63. The IC chip 62 is protected by being covered with a dome-shaped protective resin 64. The protective resin 64 is made of an insulating member. The terminal electrode E illustrated in FIG. 1 is provided on the surface of the module substrate 61 on the side opposite to the side on which the IC chip 62 and coupling coil 63 are provided. The IC module 60 thus configured is accommodated in the through hole 51 formed in the metal plate 50. In a state where the IC module 60 is accommodated in the through hole 51, the coupling coil 63 and coil pattern 120 are electromagnetically coupled to each other. Since the coil pattern 120 is connected to the coil pattern 110 functioning as an antenna coil, the IC module 60 can communicate with an external device through the coil pattern 110.

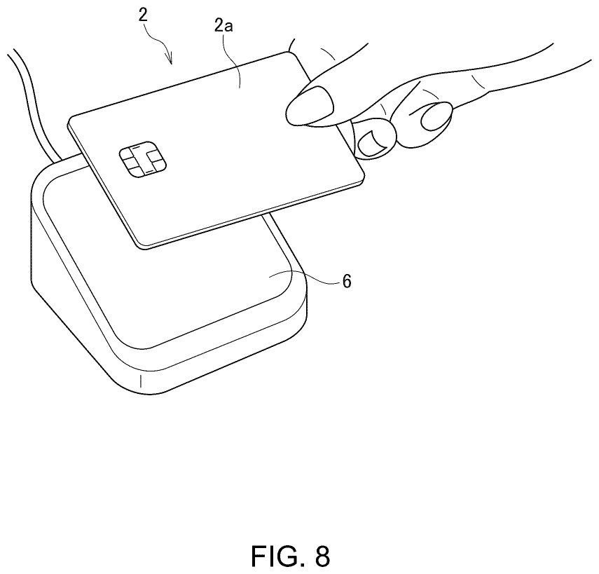

Thus, as shown in FIG. 8, when the IC card 2 is brought close to the card reader 6, communication can be achieved between the card reader 6 and IC chip 62 by the XY plane direction magnetic flux components emitted from the card reader 6. That is, the card reader 6 is coupled to the coupling coil 63 of the IC module 60 through the coil conductor 100 and can thus communicate with the IC chip 62.

As described above, even though the IC card 2 according to the present embodiment has a structure in which both surfaces thereof are constituted by the metal plates 10 and 50, between which the antenna device 1 is sandwiched, the XY plane direction magnetic flux components can interlink with the coil pattern 110 effectively due to presence of the first and second cutout areas in the respective magnetic bodies 40 and 20. To further increase the magnetic flux to interlink with the coil pattern 110, the magnetic bodies 20 and 40 may be made larger in thickness than the coil conductor 100.

Further, the magnetic body 20 is interposed between the coil pattern 120 and metal pate 10, so that it is possible to prevent occurrence of an eddy current caused due to application of magnetic flux generated by the coil pattern 120 to the metal plate 10.

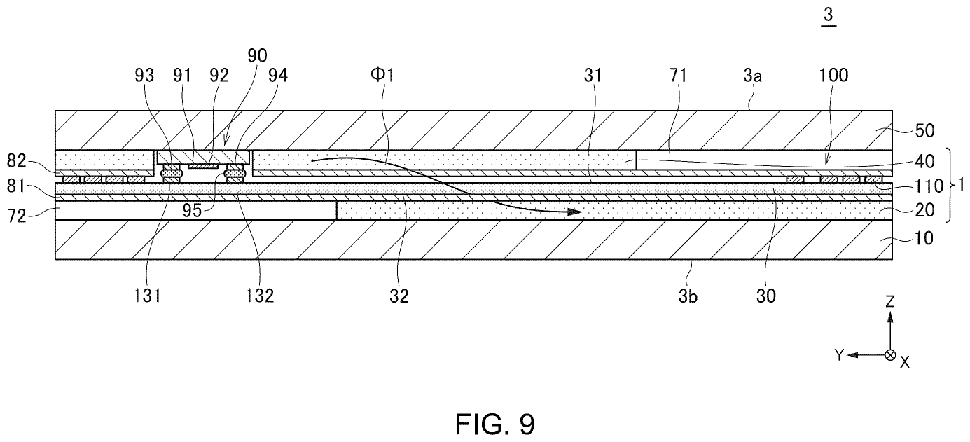

FIG. 9 is a YZ cross-sectional view of a card 3 according to a first modification.

As illustrated in FIG. 9, the IC card 3 according to modification differs from the IC card 2 the first illustrated in FIGS. 1 to 4 in that the metal plate 50 does not have the through hole 51 and that a contact-type IC module 90 is used in place of the IC module 60. The IC module 90 is disposed inside the through hole 48 of the magnetic body 40. The IC module 90 has a module substrate 91, an IC chip 92 mounted on or incorporated in the module substrate 91, and connection terminals 93 and 94. One surface of the metal plate 50 constitutes an upper surface 3a of the IC card 3. One surface of the metal plate 10 constitutes a back surface 3b of the IC card 3. Other basic configurations are the same as those of the IC card 2 illustrated in FIGS. 1 to 4, so the same reference numerals are given to the same elements, and overlapping description will be omitted.

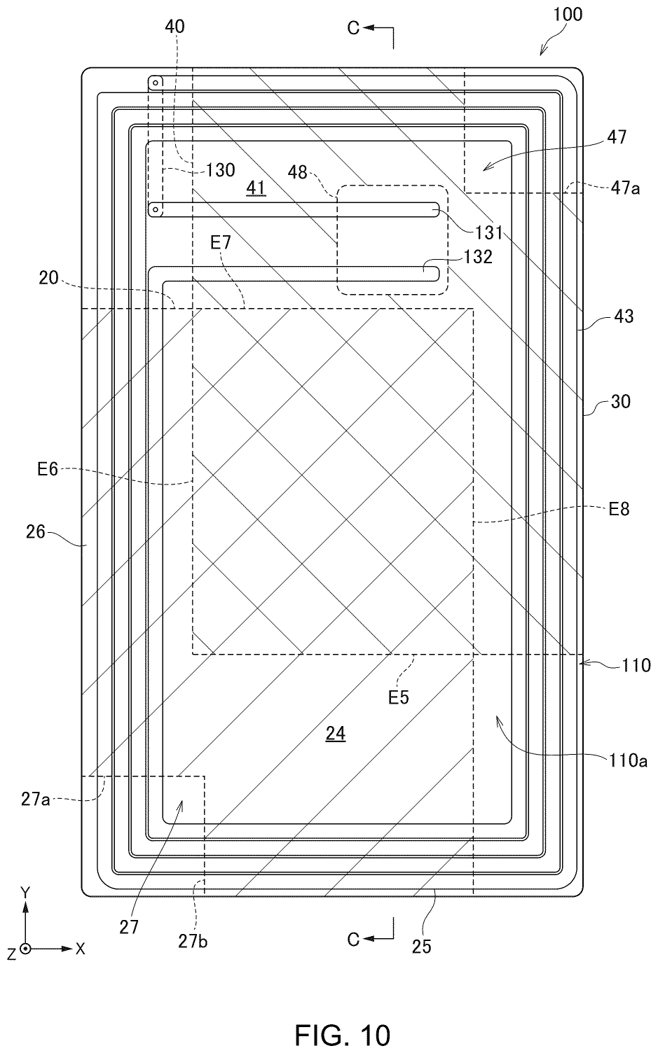

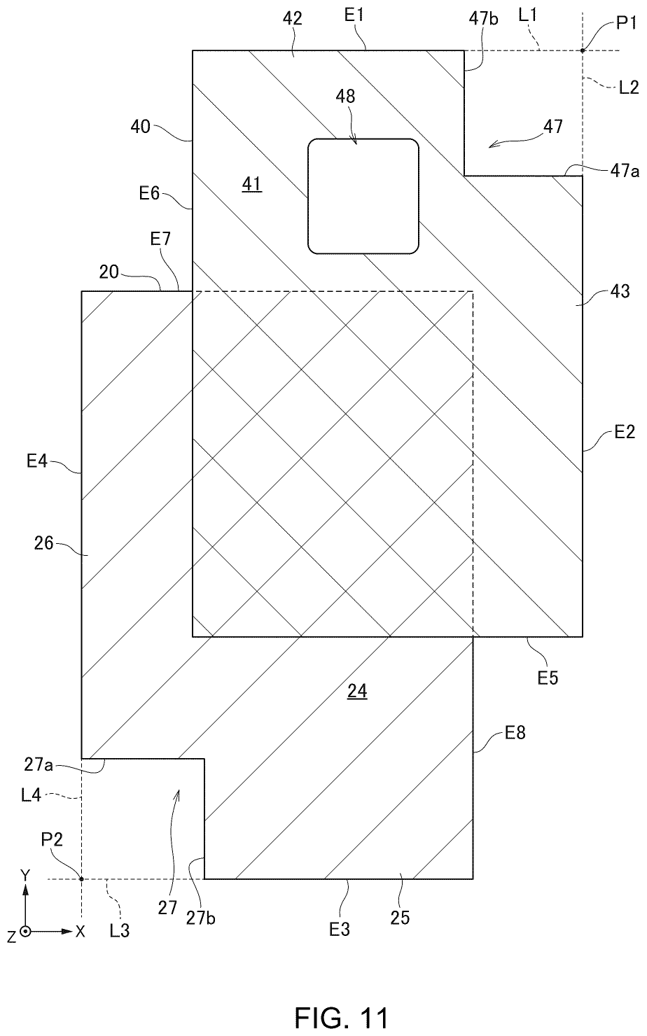

FIG. 10 is a schematic plan view for explaining the structure of the antenna device 1 applicable to the IC card 3 according to the first modification. The line C-C in FIG. 10 indicates the sectional position of FIG. 9. FIG. 11 is a schematic plan view for explaining the shapes of the magnetic bodies 20 and 40 used for the IC card 3 according to the first modification.

In the coil conductor 100 illustrated in FIG. 10, the coil pattern 120 is not provided, and outer and inner peripheral ends 131 and 132 of the coil pattern 110 are disposed inside the opening area 110a. The outermost turn of the coil pattern 110 and the outer peripheral end 131 thereof are connected to each other through a connection pattern 130 provided on a back surface 32 of the substrate 30. As illustrated in FIG. 9, the outer peripheral end 131 of the coil pattern 110 is connected to the connection terminal 93 of the IC module 90 through a solder 95, and the inner peripheral end 132 of the coil pattern 110 is connected to the connection terminal 94 of the IC module 90 through the solder 95.

As exemplified in the first modification, the IC module and coil conductor need not necessarily be electromagnetically coupled to each other but may be electrically directly connected. In this case, an anisotropic conductive material may be used for connection of the IC module and coil conductor in place of the solder 95. In this case, the magnetic body 20 need not be provided at a position overlapping the through hole 48 of the magnetic body 40. Further, although the contact-type IC module 90 is disposed inside the through hole 48 of the magnetic body 40 in the first modification illustrated in FIG. 9, it may be disposed inside the through hole 51 formed in the metal plate 50 as in the example illustrated in FIG. 3.

Further, in the first modification, the magnetic body 40 does not overlap the fourth, fifth, sixth, seventh, and eighth sections 114, 115, 116, 117, and 118 of the coil pattern 110, and outer peripheral edges E5 and E6 of the magnetic body 40 are positioned inside the opening area 110a. Similarly, in the first modification, the magnetic body 20 does not overlap the first, second, third, fourth, and eighth sections 111, 112, 113, 114, and 118 of the coil pattern 110, and outer peripheral edges E7 and E8 of the magnetic body 20 are positioned inside the opening area 110a. With this configuration, magnetic flux components that flow through the magnetic body 40 so as to bypass the coil pattern 110 without interlinking therewith and magnetic flux components that flow through the magnetic body 20 so as to bypass 110 without interlinking therewith are further reduced, so that still more magnetic flux components can interlink with the coil pattern 110.

Further, in the first modification, the first cutout area 47 of the magnetic body 40 and magnetic body 20 do not overlap each other, and the second cutout area 27 of the magnetic body 20 and magnetic body 40 do not overlap each other. Thus, the first cutout area 47 of the magnetic body 40 and magnetic body 20 need not overlap each other, and the second cutout area 27 of the magnetic body 20 and magnetic body 40 need not overlap each other.

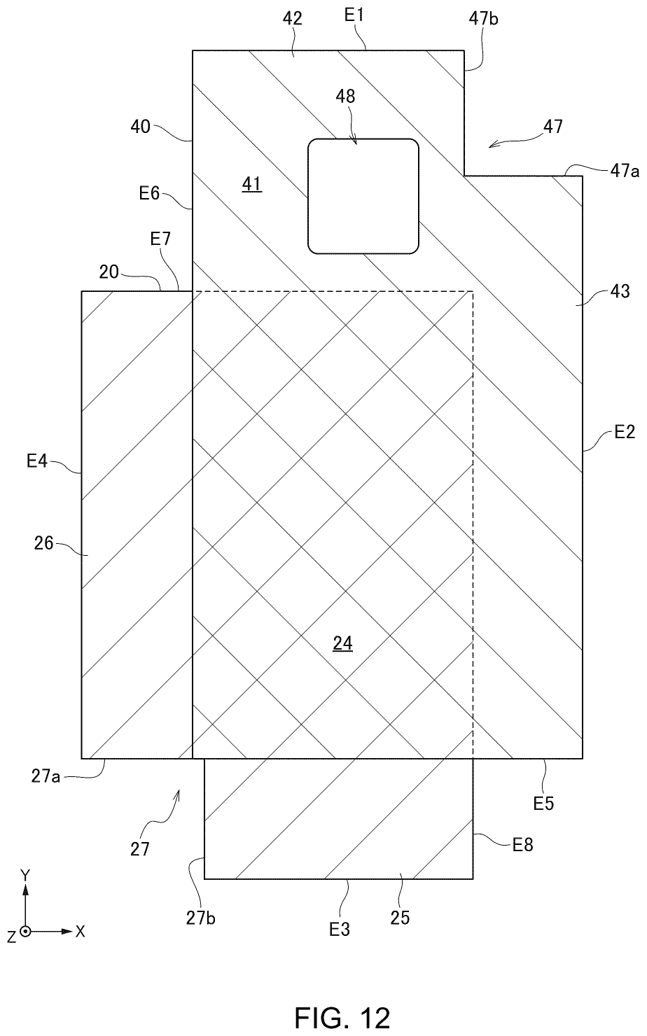

FIG. 12 is a schematic plan view for explaining the shapes of the magnetic bodies 20 and 40 according to a second modification.

The second modification differs from the structure illustrated in FIG. 11 in that the Y-direction size of the first area 41 of the magnetic body 40 is increased so as to make the outer peripheral edge E5 of the magnetic body 40 and the edge 27a defining the second cutout area 27 of the magnetic body 20 overlap each other. That is, the Y-direction position of the outer peripheral edge E5 and Y-direction position of the edge 27a substantially coincide with each other. Other basic configurations are the same as the structure illustrated in FIG. 11, so the same reference numerals are given to the same elements, and overlapping description will be omitted.

As exemplified in the second modification, the outer peripheral edge E5 and edge 27a may overlap each other. Similarly, the outer peripheral edge E7 and edge 47a may overlap each other, the outer peripheral edge E6 and edge 27b may overlap each other, and the outer peripheral edge E8 and edge 47b may overlap each other.

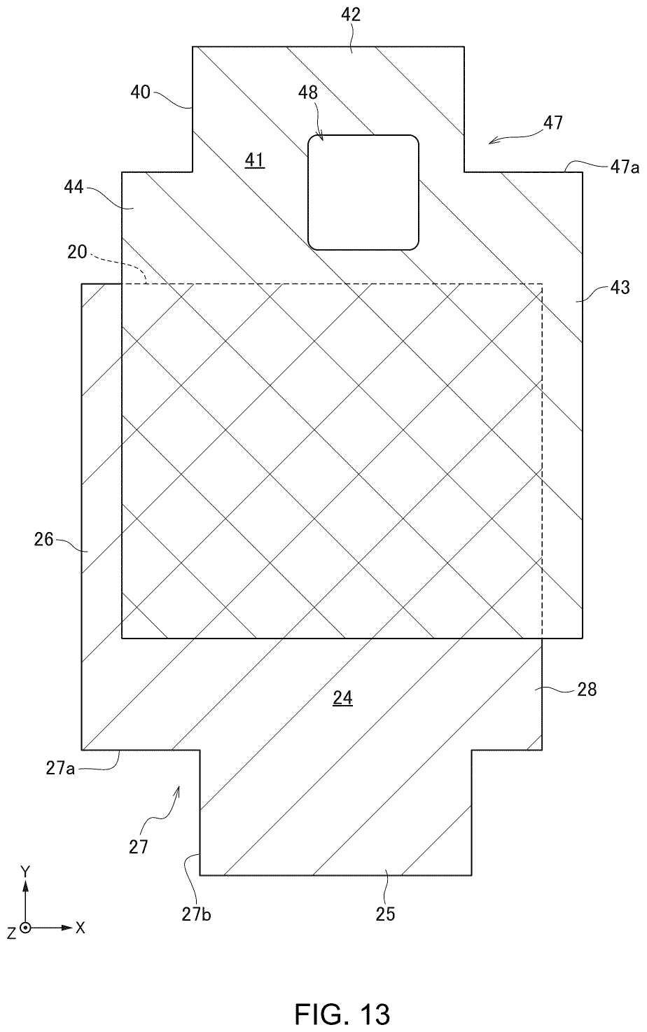

FIG. 13 is a schematic plan view for explaining the shapes of the magnetic bodies 20 and 40 according to a third modification.

The third modification differs from the structure illustrated in FIG. 11 in that areas 44 and 28 are added to the magnetic bodies 40 and 20, respectively. The area 44 protrudes from the first area 41 in the negative X-direction and overlaps the seventh section 117 of the coil pattern 110. The area 28 protrudes from the fourth area 24 in the positive X-direction and overlaps the third section 113 of the coil pattern 110. Other basic configurations are the same as the structure illustrated in FIG. 11, so the same reference numerals are given to the same elements, and overlapping description will be omitted.

As exemplified in the third modification, the magnetic bodies 20 and 40 need not have a substantially L-planar shape but may have a substantially T-planar shape. Although the area 44 overlaps the seventh section 117 of the coil pattern 110, it need not include a portion extending to the outside area of the coil pattern 110 beyond the seventh section 117 of the coil pattern 110. Similarly, although the area 28 overlaps the third section 113 of the coil pattern 110, it need not include a portion extending to the outside area of the coil pattern 110 beyond the third section 113 of the coil pattern 110. With this configuration, magnetic flux components that flow through the magnetic body 40 so as to bypass the coil pattern 110 without interlinking therewith and magnetic flux components that flow through the magnetic body 20 so as to bypass the coil pattern 110 without interlinking therewith can be reduced.

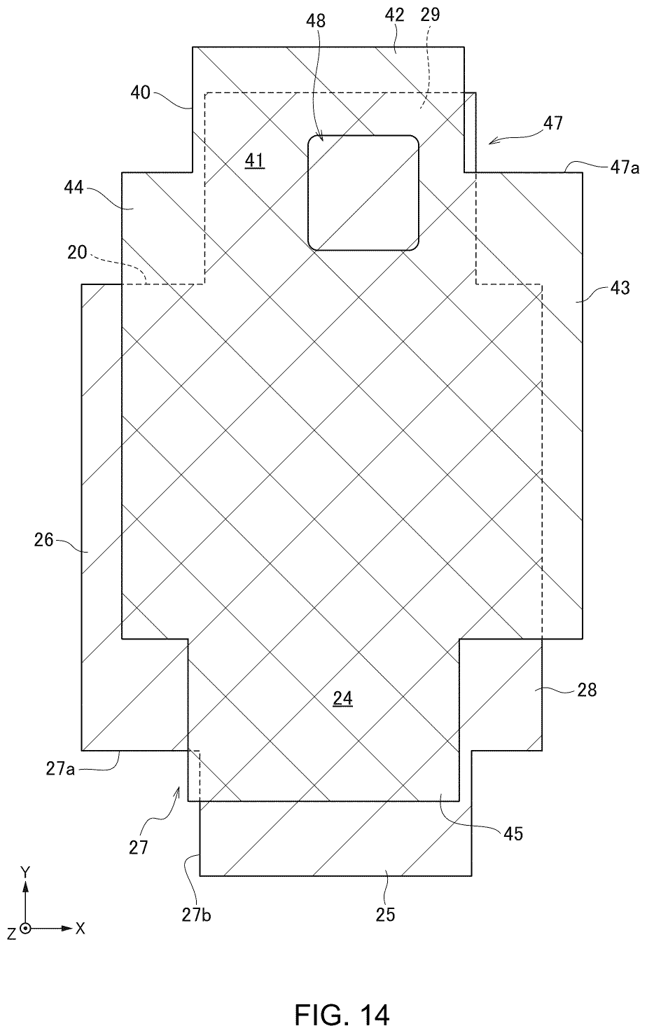

FIG. 14 is a schematic plan view for explaining the shapes of the magnetic bodies 20 and 40 according to a fourth modification.

The fourth modification differs from the structure illustrated in FIG. 13 in that areas 45 and 29 are further added to the magnetic bodies 40 and 20, respectively. The area 45 protrudes from the first area 41 in the negative Y-direction and overlaps the fifth section 115 of the coil pattern 110. The area 29 protrudes from the fourth area 24 in the positive Y-direction and overlaps the first section 111 of the coil pattern 110. Other basic configurations are the same as the structure illustrated in FIG. 13, so the same reference numerals are given to the same elements, and overlapping description will be omitted.

As exemplified in the fourth modification, the magnetic bodies 20 and 40 may each have a substantially cruciform shape. Although the area 45 overlaps the fifth section 115 of the coil pattern 110, it need not include a portion extending to the outside area of the coil pattern 110 beyond the fifth section 115 of the coil pattern 110. Similarly, although the area 29 overlaps the first section 111 of the coil pattern 110, it need not include a portion extending to the outside area of the coil pattern 110 beyond the first section 111 of the coil pattern 110. With this configuration, magnetic flux components that flow through the magnetic body 40 so as to bypass the coil pattern 110 without interlinking therewith and magnetic flux components that flow through the magnetic body 20 so as to bypass the coil pattern 110 without interlinking therewith can be reduced.

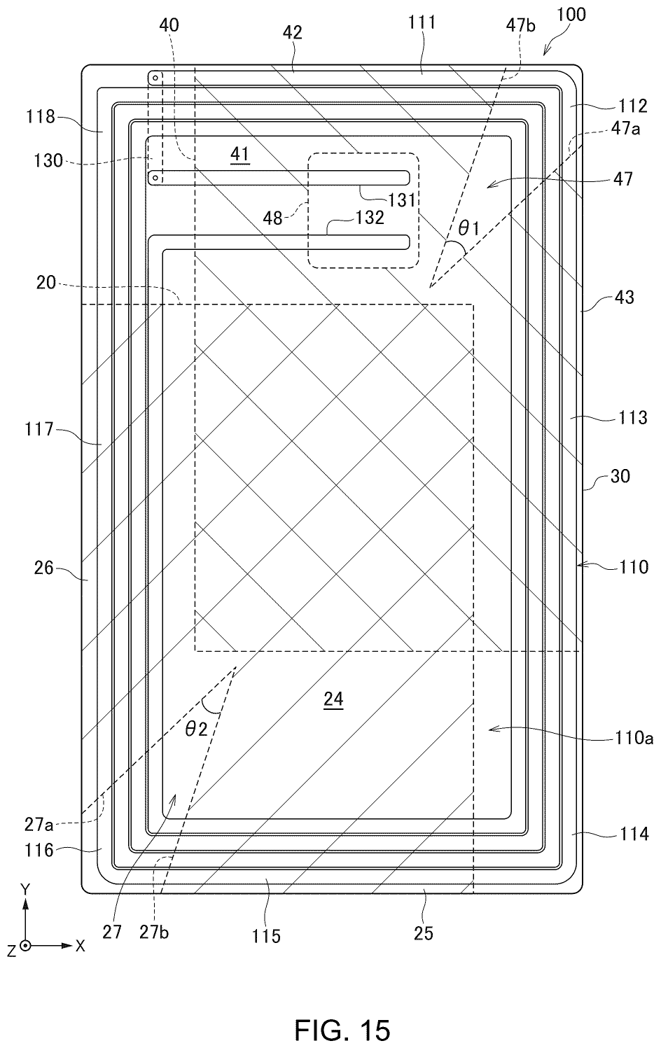

FIG. 15 is a schematic plan view for explaining the shapes of the magnetic bodies 20 and 40 according to a fifth modification.

The fifth modification differs from the structure illustrated in FIG. 10 in the shapes of the first and second cutout areas 47 and 27. Other basic configurations are the same as the structure illustrated in FIG. 10, so the same reference numerals are given to the same elements, and overlapping description will be omitted.

In the fifth modification, an angle θ1 formed by the edges 47a and 47b defining the first cutout area 47 is an acute angel. Similarly, an angle θ2 formed by the edges 27a and 27b defining the second cutout area 27 is an acute angel. This further reduces magnetic flux components that flow through the magnetic body 40 so as to bypass the coil pattern 110 without interlinking therewith and magnetic flux components that flow through the magnetic body 20 so as to bypass the coil pattern 110 without interlinking therewith, thereby further improving antenna characteristics.

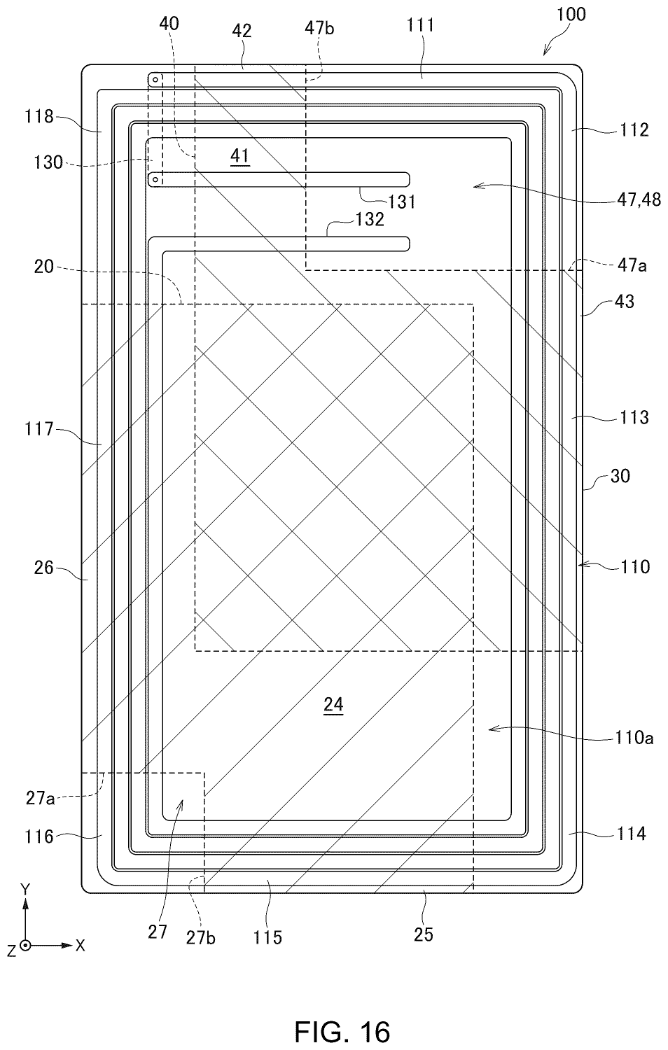

FIG. 16 is a schematic plan view for explaining the shapes of the magnetic bodies 20 and 40 according to a sixth modification.

The sixth modification differs from the structure illustrated in FIG. 10 in that the first cutout area 47 of the magnetic body 40 and through hole 48 are integrated. Other basic configurations are the same as the structure illustrated in FIG. 10, so the same reference numerals are given to the same elements, and overlapping description will be omitted.

As exemplified in the sixth modification, the first cutout area 47 of the magnetic body 40 and through hole 48 need not be formed independently of each other but may be formed integrally. This further reduces magnetic flux components that flow through the magnetic body 40 so as to bypass the coil pattern 110 without interlinking therewith.

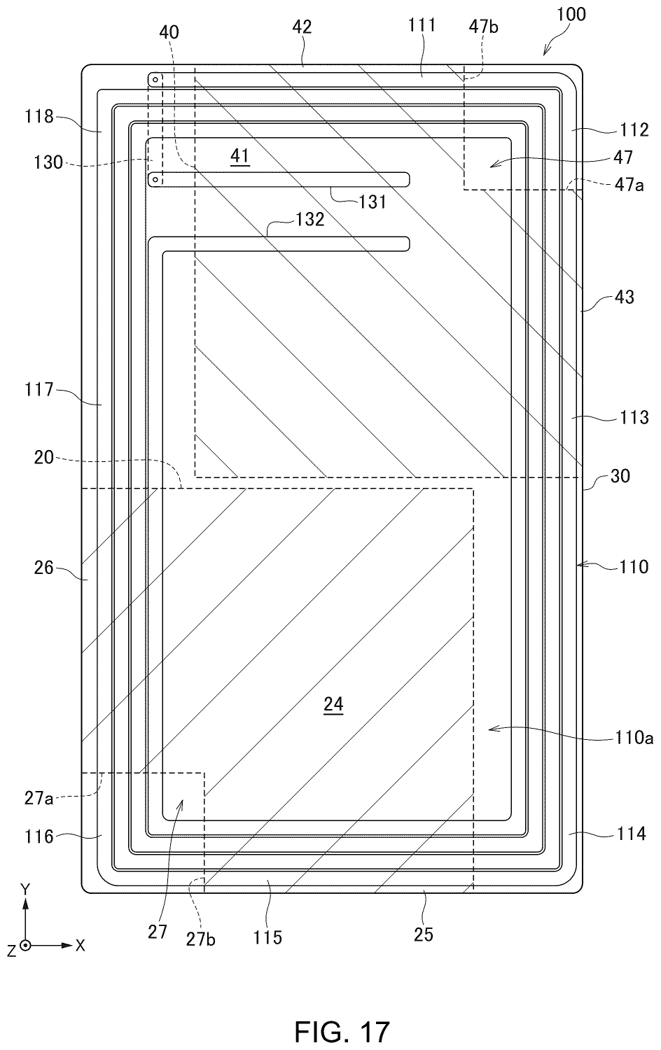

FIG. 17 is a schematic plan view for explaining the shapes of the magnetic bodies 20 and 40 according to a seventh modification.

The seventh modification differs from the structure illustrated in FIG. 10 in that the first area 41 of the magnetic body 40 and fourth area 24 of the magnetic body 20 do not overlap each other. Other basic configurations are the same as the structure illustrated in FIG. 10, so the same reference numerals are given to the same elements, and overlapping description will be omitted.

As exemplified in the seventh modification, the first area 41 of the magnetic body 40 and fourth area 24 of the magnetic body 20 need not overlap each other but may not overlap each other.

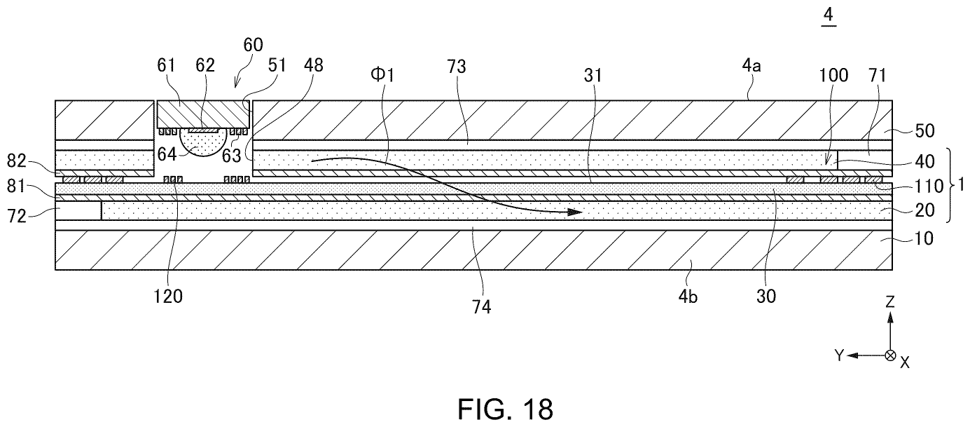

FIG. 18 is a YZ cross-sectional view of an IC card 4 according to an eighth modification.

As illustrated in FIG. 18, the IC card 4 according to the eighth modification differs from the IC card 2 illustrated in FIGS. 1 to 4 in that third and fourth spacers 73 and 74 are additionally provided. The third spacer 73 is positioned between the magnetic body 40 and metal plate 50, and the fourth spacer 74 is positioned between the magnetic body 20 and metal plate 10. One surface of the metal plate 50 constitutes an upper surface 4a of the IC card 4. One surface of the metal plate 10 constitutes a back surface 4b of the IC card 4. Other basic configurations are the same as those of the IC card 2 illustrated in FIGS. 1 to 4, so the same reference numerals are given to the same elements, and overlapping description will be omitted.

As exemplified in the eighth embodiment, when the third and fourth spacers 73 and 74 are respectively disposed between the magnetic body 40 and metal plate 50 and between the magnetic body 20 and metal plate 10, the Z-direction distance between the coil pattern 110 and metal plates 10, 50 is made larger, thereby making it possible to suppress an eddy current generated in the metal plates 10 and 50.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although the coil conductor is constituted by the coil pattern formed on the surface of the substrate in the above embodiment, a coil conductor obtained by winding a conductive wire may be used.

The technology according to the present disclosure includes the following configuration examples, but not limited thereto.

An antenna device according to an aspect of the present disclosure includes: a coil conductor; a first magnetic body disposed on one side as viewed from the coil conductor in the axial direction; and a second magnetic body disposed on the other side as viewed from the coil conductor in the axial direction. The first magnetic body has a first area that overlaps the opening area of the coil conductor in the axial direction; a second area that protrudes from the first area to one side in a first direction and overlaps the coil conductor; and a third area that protrudes from the first area to one side in a second direction perpendicular to the first direction and overlaps the coil conductor. The second magnetic body has a fourth area that overlaps the opening area of the coil conductor in the axial direction; a fifth area that protrudes from the fourth area to the other side in the first direction and overlaps the coil conductor; and a sixth area that protrudes from the fourth area to the other side in the second direction and overlaps the coil conductor. The first magnetic body has a first cutout area such that an outer peripheral edge of the first magnetic body is positioned at the inner side than a first intersection between a first virtual line obtained by extending the outer peripheral edge of the second area in the second direction and a second virtual line obtained by extending the outer peripheral edge of the third area in the first direction. This can reduce magnetic flux components that flow through the first magnetic body so as to bypass the coil conductor without interlinking therewith.

In the above antenna device, the second area of the first magnetic body may include a portion extending to the outside area of the coil conductor, and the third area of the first magnetic body may include a portion extending to the outside area of the coil conductor. This allows more magnetic flux components in the first and second directions to interlink with the coil conductor.

In the above antenna device, the outer peripheral edge of the first area of the first magnetic body that is positioned on the side opposite to the side on which the second area is provided may be positioned at the inner side than the outside area of the coil conductor. This can further reduce magnetic flux components that flow through the first magnetic body in the first direction so as to bypass the coil conductor without interlinking therewith.

In the above antenna device, the outer peripheral edge of the first area of the first magnetic body that is positioned on the side opposite to the side on which the third area is provided may be positioned at the inner side than the outside area of the coil conductor. This can further reduce magnetic flux components that flow through the first magnetic body in the second direction so as to bypass the coil conductor without interlinking therewith.

In the above antenna device, the second magnetic body may have a second cutout area such that an outer peripheral edge of the second magnetic body is positioned at the inner side than a second intersection between a third virtual line obtained by extending the outer peripheral edge of the fifth area in the second direction and a fourth virtual line obtained by extending the outer peripheral edge of the sixth area in the first direction. This can reduce magnetic flux components that flow through the second magnetic body so as to bypass the coil conductor without interlinking therewith.

In the above antenna device, the outer peripheral edge of the fourth area of the second magnetic body that is positioned on the side opposite to the side on which the fifth area is provided may be positioned at the inner side than the outside area of the coil conductor, and the outer peripheral edge of the fourth area of the second magnetic body that is positioned on the side opposite to the side on which the sixth area is provided may be positioned at the inner side than the outside area of the coil conductor. This can further reduce magnetic flux components that flow through the second magnetic body in the first and second directions so as to bypass the coil conductor without interlinking therewith.

In the above antenna device, the first area of the first magnetic body and the fourth area of the second magnetic body may overlap each other in the axial direction. This can reduce a magnetic resistance between the first and second magnetic bodies.

In the above antenna device, the first cutout area of the first magnetic body may overlap the opening area of the coil conductor. This further reduces magnetic flux components that flow through the first magnetic body so as to bypass the coil conductor without interlinking therewith.

In the above antenna device, the second cutout area of the second magnetic body may overlap the opening area of the coil conductor. This further reduces magnetic flux components that flow through the second magnetic body so as to bypass the coil conductor without interlinking therewith.

In the above antenna device, the first cutout area of the first magnetic body may overlap the fourth area of the second magnetic body. This can further reduce a magnetic resistance between the first and second magnetic bodies.

In the above antenna device, the first and second magnetic bodies may be larger in thickness than the coil conductor. This can further increase magnetic flux to interlink with the coil conductor.

The above antenna device may further include a first spacer that is disposed in the same plane as the first magnetic body and overlaps the second magnetic body in the axial direction. This can enhance the flatness of the one surface side of the antenna device.

The above antenna device may further include a second spacer that is disposed in the same plane as the second magnetic body and overlaps the first magnetic body in the axial direction. This can enhance the flatness of the other surface side of the antenna device.

An IC card according to an embodiment of the present disclosure includes the above-configured antenna device. Thus, there can be provided an IC card capable of performing wireless communication.

The above IC card may further include a first card substrate made of metal and a second card substrate made of metal, and the antenna device may be disposed between the first and second card substrates. Thus, there can be provided an IC card having a structure in which both surfaces thereof are constituted by a metal material.

The above IC card may have a structure in which the first card substrate, the first magnetic body, the second magnetic body, and the second card substrate are laminated in this order in the axial direction and may further have a third spacer disposed between the first magnetic body and first card substrate and a fourth spacer disposed between the second magnetic body and second card substrate. Thus, the distance between the first card substrate and first magnetic body in the axial direction is made larger, and the distance between the second card substrate and second magnetic body in the axial direction is made larger, making it possible to suppress an eddy current generated in the first and second card substrates.

What is claimed is:

1. An antenna device comprising:
a coil conductor;
a first magnetic body disposed on one side as viewed from the coil conductor in an axial direction; and
a second magnetic body disposed on other side as viewed from the coil conductor in the axial direction,
wherein the first magnetic body has:
a first area that overlaps an opening area of the coil conductor in the axial direction;
a second area that protrudes from the first area to one side in a first direction and overlaps the coil conductor; and
a third area that protrudes from the first area to one side in a second direction perpendicular to the first direction and overlaps the coil conductor,
wherein the second magnetic body has:
a fourth area that overlaps the opening area of the coil conductor in the axial direction;
a fifth area that protrudes from the fourth area to other side in the first direction and overlaps the coil conductor; and
a sixth area that protrudes from the fourth area to other side in the second direction and overlaps the coil conductor, and
wherein the first magnetic body has a first cutout area such that an outer peripheral edge of the first magnetic body is positioned at an inner side than a first intersection between a first virtual line obtained by extending an outer peripheral edge of the second area in the second direction and a second virtual line obtained by extending an outer peripheral edge of the third area in the first direction.

2. The antenna device as claimed in claim 1,
wherein the second area of the first magnetic body includes a portion extending to an outside area of the coil conductor, and
wherein the third area of the first magnetic body includes a portion extending to the outside area of the coil conductor.

3. The antenna device as claimed in claim 2, wherein an outer peripheral edge of the first area of the first magnetic body that is positioned on a side opposite to a side on which the second area is provided is positioned at an inner side than the outside area of the coil conductor.

4. The antenna device as claimed in claim 3, wherein an outer peripheral edge of the first area of the first magnetic body that is positioned on a side opposite to a side on which the third area is provided is positioned at an inner side than the outside area of the coil conductor.

5. The antenna device as claimed in claim 1, wherein the second magnetic body has a second cutout area such that an outer peripheral edge of the second magnetic body is positioned at an inner side than a second intersection between a third virtual line obtained by extending an outer peripheral edge of the fifth area in the second direction and a fourth virtual line obtained by extending an outer peripheral edge of the sixth area in the first direction.

6. The antenna device as claimed in claim 5,
wherein an outer peripheral edge of the fourth area of the second magnetic body that is positioned on a side opposite to a side on which the fifth area is provided is positioned at an inner side than an outside area of the coil conductor, and
wherein an outer peripheral edge of the fourth area of the second magnetic body that is positioned on a side opposite to a side on which the sixth area is provided is positioned at an inner side than the outside area of the coil conductor.

7. The antenna device as claimed in claim 1, wherein the first area of the first magnetic body and the fourth area of the second magnetic body overlap each other in the axial direction.

8. The antenna device as claimed in claim 1, wherein the first cutout area of the first magnetic body overlaps the opening area of the coil conductor.

9. The antenna device as claimed in claim 5, wherein the second cutout area of the second magnetic body overlaps the opening area of the coil conductor.

10. The antenna device as claimed in claim 8, wherein the first cutout area of the first magnetic body overlaps the fourth area of the second magnetic body.

11. The antenna device as claimed in claim 1, wherein the first and second magnetic bodies are larger in thickness than the coil conductor.

12. The antenna device as claimed in claim 1, further comprising a first spacer that is disposed in a same plane as the first magnetic body and overlaps the second magnetic body in the axial direction.

13. The antenna device as claimed in claim 12, further comprising a second spacer that is disposed in a same plane as the second magnetic body and overlaps the first magnetic body in the axial direction.

14. An IC card comprising an antenna device,
wherein the antenna device comprises:
a coil conductor;
a first magnetic body disposed on one side as viewed from the coil conductor in an axial direction; and
a second magnetic body disposed on other side as viewed from the coil conductor in the axial direction,
wherein the first magnetic body has:
a first area that overlaps an opening area of the coil conductor in the axial direction;
a second area that protrudes from the first area to one side in a first direction and overlaps the coil conductor; and
a third area that protrudes from the first area to one side in a second direction perpendicular to the first direction and overlaps the coil conductor,
wherein the second magnetic body has:
a fourth area that overlaps the opening area of the coil conductor in the axial direction;
a fifth area that protrudes from the fourth area to other side in the first direction and overlaps the coil conductor; and
a sixth area that protrudes from the fourth area to other side in the second direction and overlaps the coil conductor, and
wherein the first magnetic body has a first cutout area such that an outer peripheral edge of the first magnetic body is positioned at an inner side than a first intersection between a first virtual line obtained by extending an outer peripheral edge of the second area in the second direction and a second virtual line obtained by extending an outer peripheral edge of the third area in the first direction.

15. The IC card as claimed in claim 14, further comprising:
a first card substrate made of metal; and
a second card substrate made of metal,
wherein the antenna device is disposed between the first and second card substrates.

16. The IC card as claimed in claim 15, further comprising:
a third spacer disposed between the first magnetic body and first card substrate; and
a fourth spacer disposed between the second magnetic body and second card substrate,
wherein the first card substrate, the first magnetic body, the second magnetic body, and the second card substrate are laminated in this order in the axial direction.
